(19) United States
(12) Patent Application Publication
(10) Pub. No.: US 2026/0255270 A1
(43) Pub. Date: Aug. 27, 2026

(54) UPLINK (UL) WAKE-UP SIGNAL (WUS) COMMUNICATION FOR DIFFERENT RADIO RESOURCE CONTROL (RRC) MODES

(71) Applicant: Lenovo (United States) Inc., Morrisville, NC (US)

(72) Inventors: Ali Ramadan Ali, Kraiburg (DE); Karthikeyan Ganesan, Nauheim (DE); Hossein Bagheri, Urbana, IL (US)

(73) Assignee: Lenovo (United States) Inc., Morrisville, NC (US)

(21) Appl. No.: 19/464,390

(22) Filed: Jan. 29, 2026

(51) Int. Cl. H04W 52/02; H04W 56/00

(52) U.S. Cl. CPC H04W 52/0235; H04W 56/0045

(57) ABSTRACT

Various aspects of the present disclosure relate to uplink wake-up signal (UL-WUS) transmission in idle or inactive mode. An apparatus, such as a UE, may select, based on an absence of the SSB, a default UL-WUS configuration. The default UL-WUS configuration may include a predefined time-domain sequence, predefined sequence length, predefined bandwidth, and predefined repetition pattern. The UE may transmit the predefined time-domain sequence according to the default UL-WUS configuration.

### TECHNICAL FIELD

The present disclosure relates to wireless communications, and more specifically to communicating (e.g., transmitting, receiving) an uplink (UL) wake-up signal (WUS) for different radio resource control (RRC) modes, for example, an RRC idle mode or an RRC inactive mode, or both.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to select, based at least in part on an absence of a synchronization signal block (SSB), a default uplink wake-up signal (UL-WUS) configuration; and/or transmit the predefined time-domain sequence according to the default UL-WUS configuration. The default UL-WUS configuration may include a predefined time-domain sequence, a predefined sequence length associated with the predefined time-domain sequence, a predefined bandwidth for transmission of the predefined time-domain sequence, and predefined repetition pattern for transmission of the predefined time-domain sequence.

A processor (e.g., a standalone processor chipset, or a component of a UE) for wireless communication is described. The processor may be configured to, capable of, or operable to perform one or more operations as described herein. For example, the processor may be configured to, capable of, or operable to select, based at least in part on an absence of a SSB, a default UL-WUS configuration; and/or transmit the predefined time-domain sequence according to the default UL-WUS configuration. The default UL-WUS configuration may include a predefined time-domain sequence, a predefined sequence length associated with the predefined time-domain sequence, a predefined bandwidth for transmission of the predefined time-domain sequence, and predefined repetition pattern for transmission of the predefined time-domain sequence.

A method performed or performable by a UE for wireless communication is described. The method may include determining an absence of a SSB. The method may include selecting, based at least in part on an absence of a SSB, a default UL-WUS configuration; and/or transmitting the predefined time-domain sequence according to the default UL-WUS configuration. The default UL-WUS configuration may include a predefined time-domain sequence, a predefined sequence length associated with the predefined time-domain sequence, a predefined bandwidth for transmission of the predefined time-domain sequence, and predefined repetition pattern for transmission of the predefined time-domain sequence.

In some implementations of the UE, the processor, and the method described herein, the predefined bandwidth may be associated with a frequency band for transmission of the predefined time-domain sequence. The UE may transmit, to a base station, the predefined time-domain sequence irrespective of a timing advance associated with the base station. To transmit the predefined time-domain sequence irrespective of the timing advance, UE may transmit the predefined time-domain sequence without aligning transmission of the predefined time-domain sequence to a frame boundary, a slot boundary, or a symbol boundary associated with the base station. The UE may receive a coarse time reference from a GNSS; and align transmission of the predefined time-domain sequence to a coarse periodic time grid based at least in part on the coarse time reference received from the GNSS. The UE may retrieve, from local memory of the UE, a stored UL-WUS configuration.

In some implementations of the UE, the processor, and the method described herein, the UE, the processor, and the method may further be configured to, capable of, operable to, performed to, or performable to determine whether the retrieved stored UL-WUS configuration is invalid based at least in part on a time threshold associated with the stored UL-WUS configuration. The default UL-WUS configuration may be selected based at least in part on the retrieved stored UL-WUS configuration being invalid. The UE may determine whether an UL-WUS configurations is stored in local memory of the UE. The default UL-WUS configuration may be selected based at least in part on an absence of a stored UL-WUS configuration in local memory of the UE. The predefined time-domain sequence may include a Zadoff-Chu sequence, a m-sequence, or a Golay sequence.

An NE (e.g., a base station) for wireless communication is described. The NE may be configured to, capable of, or operable to perform one or more operations as described herein. For example, the NE may be configured to, capable of, or operable to transmit a default UL-WUS configuration, and receive the predefined time-domain sequence according to the default UL-WUS configuration. The default UL-WUS configuration may include a predefined time-domain sequence, a predefined sequence length associated with the predefined time-domain sequence, a predefined bandwidth for transmission of the predefined time-domain sequence, and predefined repetition pattern of transmitting for transmission of the predefined time-domain sequence.

A processor (e.g., a standalone processor chipset, or a component of a NE) for wireless communication is described. The processor may be configured to, capable of, or operable to perform one or more operations as described herein. For example, the processor may be configured to, capable of, or operable to transmit a default UL-WUS configuration, and receive the predefined time-domain sequence according to the default UL-WUS configuration. The default UL-WUS configuration may include a predefined time-domain sequence, a predefined sequence length associated with the predefined time-domain sequence, a predefined bandwidth for transmission of the predefined time-domain sequence, and predefined repetition pattern of transmitting for transmission of the predefined time-domain sequence.

A method performed or performable by an NE (e.g., a base station) for wireless communication is described. The method may include transmitting a default UL-WUS configuration, and receiving the predefined time-domain sequence according to the default UL-WUS configuration. The default UL-WUS configuration may include a predefined time-domain sequence, a predefined sequence length associated with the predefined time-domain sequence, a predefined bandwidth for transmission of the predefined time-domain sequence, and predefined repetition pattern of transmitting for transmission of the predefined time-domain sequence.

In some implementations of the NE, the processor, and the method described herein, may monitor the predefined bandwidth for the predefined time-domain sequence using a low-power WUR; receive an UL-WUS based at least in part on a time-domain correlation satisfying a threshold; and transmit information, in response to the receive UL-WUS, for time and frequency synchronization. The time-domain correlation may be associated with the predefined repetition pattern.

### BRIEF DESCRIPTION OF THE DRAWINGS

FIG. 1 illustrates an example of a wireless communications system in accordance with aspects of the present disclosure.

FIGS. 2a-3c illustrate example systems in accordance with aspects of the present disclosure.

FIG. 4 illustrates an example time-domain sequence in accordance with aspects of the present disclosure.

FIG. 5 illustrates an example multi-stage UL-WUS in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In future 6G systems, significant network energy savings may be expected to emerge from enabling NE, such as next-generation base stations (gNBs) to transition into (e.g., enter) deeper low-power states. A significant portion of existing high energy consumption stems from the periodic transmission of broadcast signals, such as synchronization signal blocks (SSBs) and system information (e.g., system information blocks (SIBs) even when no UE is within a cell associated with a gNB. To address this inefficiency, UL-WUS mechanisms have been studied in Release 19and Release 20 of 3GPP under energy-efficiency initiatives. These mechanisms allow a UE to transmit wake-up signal (WUS) to trigger on-demand SSB or on-demand SIB1 transmission by a gNB.

However, for a UE to transmit an UL-WUS, the UE have to possess an UL-WUS configuration in advance. Such configuration may be obtained from an on-demand SSB (in case of on-demand SIB1) or from an assistant cell that provides downlink signaling, including SSB. In standalone deployments without an assistant cell, a UE in an RRC idle state (also referred to herein solely as an idle state) may be out of synchronization when attempting to request an on-demand SSB (or on-demand SIB). This out-of-synchronization condition may create a critical challenge for reliable transmission of UL-WUS. Thus, a circular dependency may arise, i.e., the UE requires UL-WUS to obtain synchronization recovery via on-demand SSB, but UL-WUS itself requires synchronization. This presents an obstacle to achieving low-energy network operation while maintaining reliable UE procedures.

Aspects of the present disclosure are described in the context of a wireless communications system, and address the above challenges by providing techniques for enabling UL-WUS transmission for on-demand SSB even in the absence of an UL-WUS configuration. For example, the wireless communication system may select a default UL-WUS configuration to transmit a predefine time-domain sequence if a SSB was absent.

By performing the techniques described herein, an UE can transmit an UL-WUS with minimal or no UL-WUS configuration. Some aspects of the present disclosure include enabling the UE to transmit a UL-WUS as a time-domain waveform or sequence without requiring synchronization with the network (e.g., a base station). Additional aspects of the present disclosure include enabling low power WUR operation, for example, at the base station, and supporting multi-stage wake-up procedures, thereby reducing false alarms associated with UL-WUS detection and improving overall system energy efficiency.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

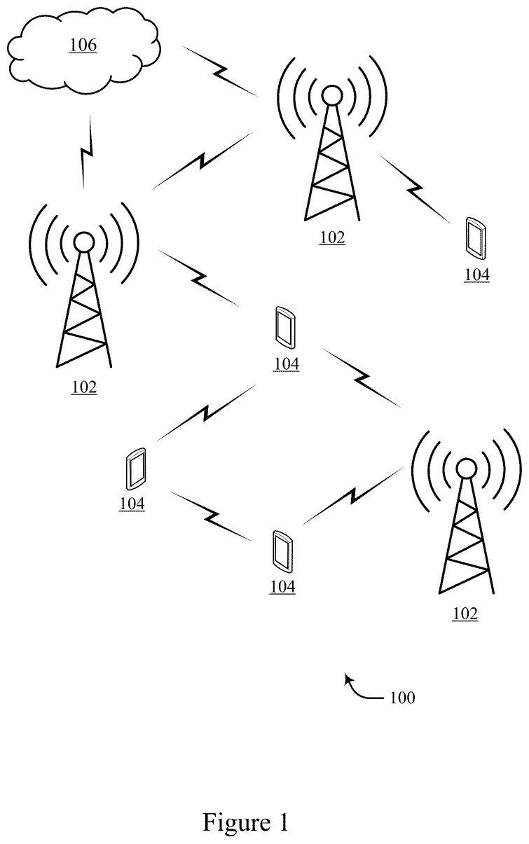

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1, μ=2,μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 determines an absence of a SSB. The UE selects, based on the absence of the SSB, a default UL-WUS configuration. The default UL-WUS configuration includes a predefined time-domain sequence, predefined sequence length, predefined bandwidth, and predefined repetition pattern. The UE further transmits the predefined time-domain sequence according to the default UL-WUS configuration. An NE 102 (e.g., a base station, gNB) monitors a predefined uplink bandwidth for a predefined time-domain sequence using a low-power WUR. The NE performs a time-domain correlation between the predefined time-domain sequence and a received time-domain signal. When the time-domain correlation exceeds a predefined threshold, the NE detects an UL-WUS. The time-domain correlation may be associated with a predefined pattern. The NE transmits a downlink signal in response to detecting the UL-WUS to enable a UE to obtain time and frequency synchronization.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Agreements had been made on on-demand SSB and on-demand SIB1. For the further study of on-demand SIB1 for idle/inactive mode UE, RAN1 focuses its studies on the three cases. Case 1 is Option 1+A+X; Case 2 is Option 1+B+X; and Case 3 is Option 2+B+Y. The different options have different definitions based on different occasions. For example, for on target cell of UL-WUS transmission, option 1 is defined as UE transmits UL-WUS to NES Cell, and option 2 is defined as UE transmits UL-WUS to Cell A. For on configuration provision for UL-WUS transmission, option A is defined as UE obtains the UL-WUS configuration from NES Cell, and option B is defined as UE obtains the UL-WUS configuration from Cell A. On receiving of SIB1, option X is defined as UE receives on-demand SIB1 from NES Cell. Option Y is defined as UE receives on-demand SIB1 from Cell A.

Agreements were made on study and evaluate network (NW) energy savings and the impact on UE performance and user experience with respect to 20 ms and longer periodicities of sync signal at least for initial access with several considerations, for example, BS assumptions and UE impact. For BS assumptions, agreements were made on cell-common signaling (e.g., sync signal(s), broadcast PDCCH, SIB-1, SIB, paging, PRACH), for example, clustered provisioning of different cell-common signaling were agreed on, and on-demand provisioning of different cell-common signaling were agreed on. For UE impact, agreements had been made on cell search complexity and latency, UE Power consumption, sync signal detection, coverage and tracking performance, RRM, mobility, beam management, and improvements to address identified impact. Cell search complexity and latency include frequency search latency. Other properties are not precluded. Examples of improvements to address identified impact may include additional sync signal needs, adaptation of sync signal transmission periodicity, and/or sparser synch raster.

Agreements were made on study and evaluate on-demand and/or periodic SIB-1 transmission with respect to NW energy savings potential and UE power consumption impact, SIB-1 acquisition delay, NW and UE complexity, coverage, and applicable deployment scenarios. Applicable deployment scenarios may include standalone cell/carrier, or multiple TRPs/cells/carriers.

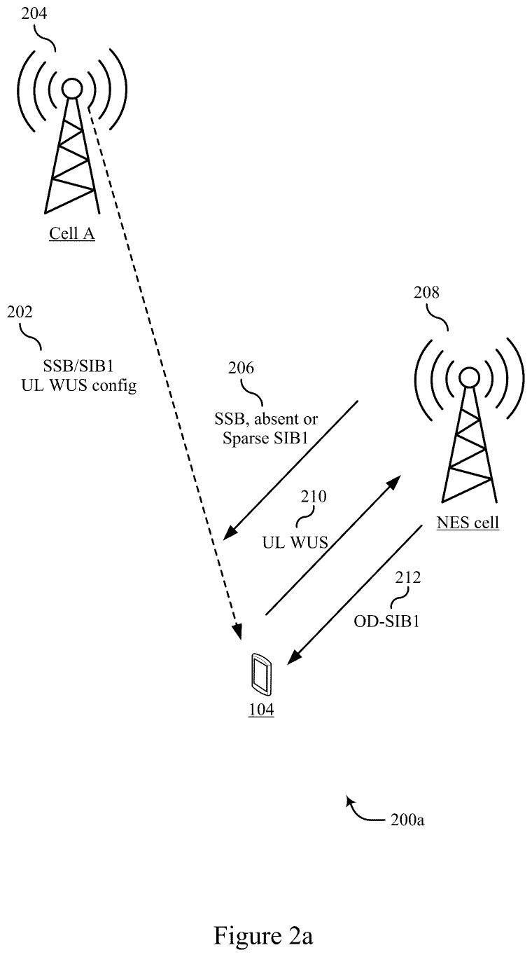

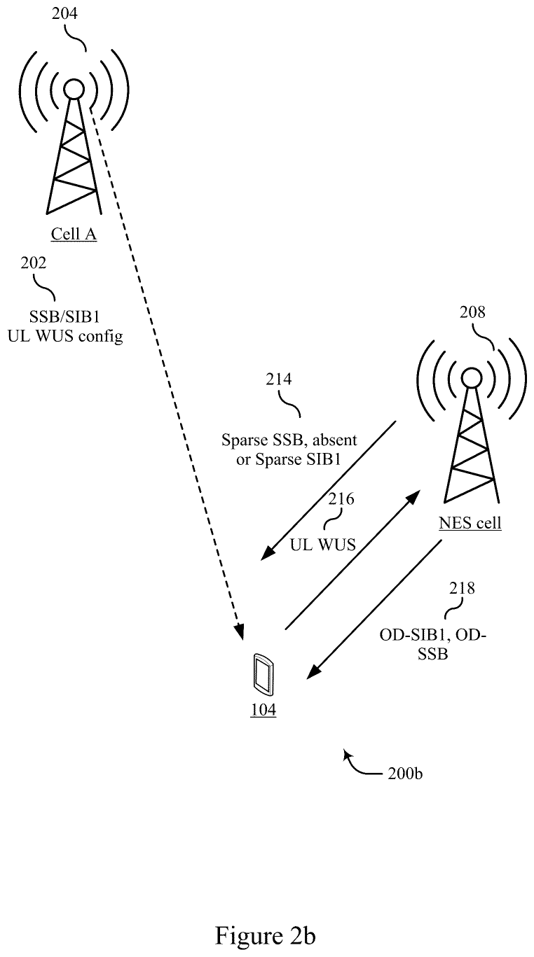

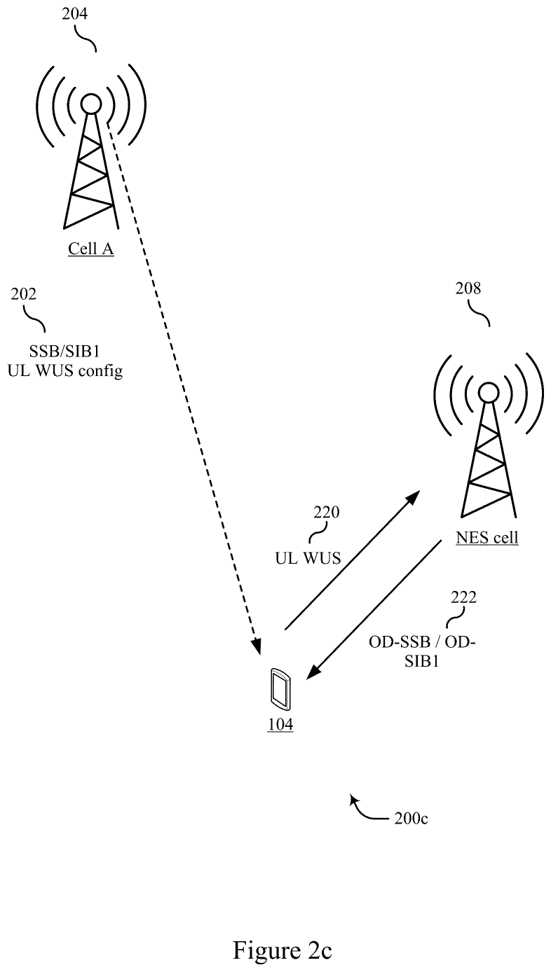

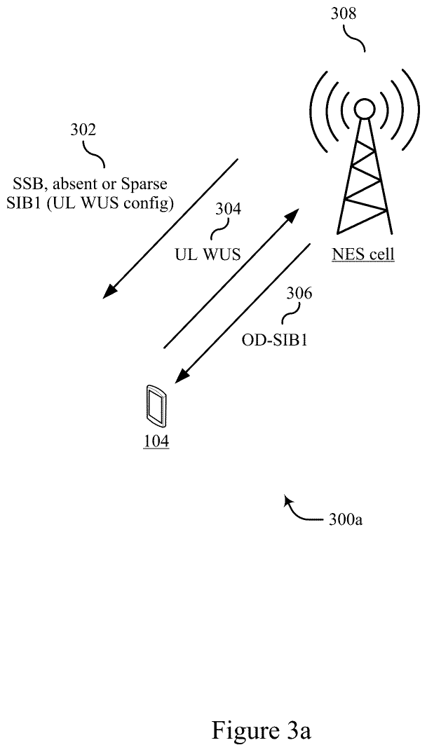

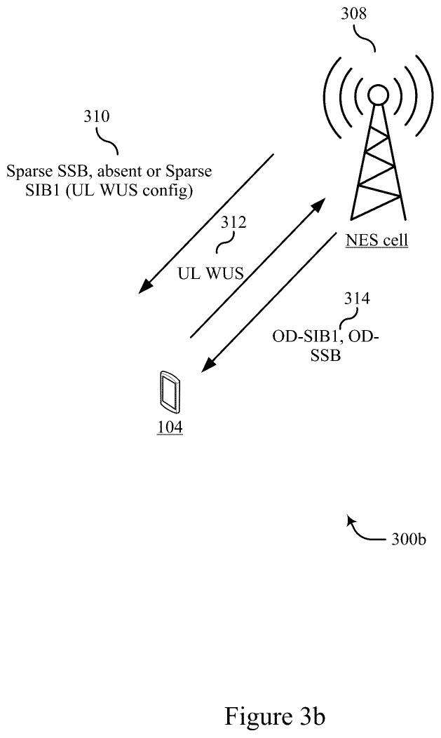

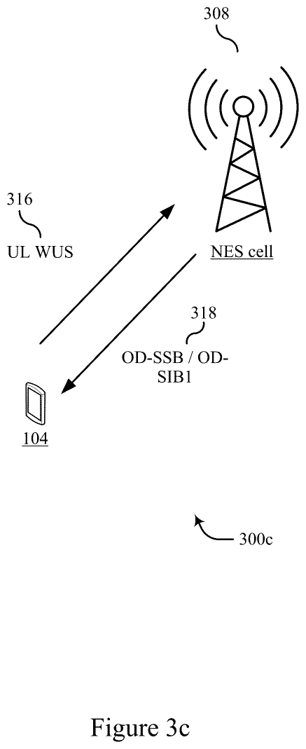

FIGS. 2a-2c and 3a-3c show different cases of UL-WUS configuration and transmission to request on-demand SSB, on-demand SIB1, or both. In case of non-stand-alone deployment (case 2a, 2b, 2c) UL-WUS configuration may be obtained from assistant cell (cell A), while UL-WUS is transmitted towards NES cell to wake-up and send on-demand broadcast signals. Although WUS-configuration is easier and straightforward, the overall energy saving is limited. In case of stand-alone deployment scenarios (cases 3a, 3b, 3c), UL-WUS can be obtained from the sparse SIB1 or from SSB in cases 3a and 3b. However, in case 3c, for which high energy saving gain can be obtain as BS is in deep sleep state with no SSB transmission, UL-WUS configuration is not available at the UE to transmit UL-WUS. A new procedure may be required to enable transmitting UL-WUS.

FIG. 2a illustrates a system 200a in accordance with aspects of the present disclosure. In the system 200a, a UL-WUS configuration and transmission to request on-demand SSB or on-demand SIB1 may be performed. At 202, a Cell A 204 (e.g., a NE 102) may transmit a SSB or SIB1 which includes a UL-WUS configuration to a UE 104. At 206, an NES cell 208 (e.g., a NE 102) may transmit SSB, absent or sparse SIB1 to the UE 104. At 210, the UE 104 may transmit UL-WUS to the NES cell 208. At 212, the NES cell 208 may transmit OD-SIB1 to the UE 104.

FIG. 2b illustrates a system 200b in accordance with aspects of the present disclosure. In the system 200b, a UL-WUS configuration and transmission to request on-demand SSB or on-demand SIB1 may be performed. At 202, a Cell A (e.g., a NE 102) may transmit a SSB or SIB1 which includes a UL-WUS configuration to a UE 104. At 214, an NES cell 208 (e.g., a NE 102) may transmit sparse SSB, absent or sparse SIB1 to the UE 104. At 216, the UE 104 may transmit UL-WUS to the NES cell 208. At 218, the NES cell 208 may transmit OD-SIB1 or OD-SSB to the UE 104.

FIG. 2c illustrates a system 200c in accordance with aspects of the present disclosure. In the system 200c, a UL-WUS configuration and transmission to request on-demand SSB or on-demand SIB1 may be performed. At 202, a Cell A (e.g., an NE 102) may transmit a SSB or SIB1 which includes a UL-WUS configuration to a UE 104. At 220, the UE 104 may transmit UL-WUS to the NES cell 208 (e.g., a NE 102). At 222, the NES cell 208 may transmit OD-SIB1 or OD-SSB to the UE 104.

FIG. 3a illustrates a system 300a in accordance with aspects of the present disclosure. In the system 300a, a UL-WUS configuration and transmission to request on-demand SSB or on-demand SIB1 may be performed. At 302, an NES cell 308 (e.g., a NE 102) may transmit SSB, absent or sparse SIB1 (UL-WUS configuration) to the UE 104. At 304, the UE 104 may transmit UL-WUS to the NES cell 308. At 306, the NES cell 308 may transmit OD-SIB1 to the UE 104.

FIG. 3b illustrates a system 300b in accordance with aspects of the present disclosure. In the system 300b, a UL-WUS configuration and transmission to request on-demand SSB or on-demand SIB1 may be performed. At 310, an NES cell 308 (e.g., a NE 102) may transmit sparse SSB, absent or sparse SIB1 (UL-WUS configuration) to the UE 104. At 312, the UE 104 may transmit UL-WUS to the NES cell 308. At 314, the NES cell 308 may transmit OD-SIB1 or OD-SSB to the UE 104.

FIG. 3c illustrates a system 300c in accordance with aspects of the present disclosure. In the system 300c, a UL-WUS configuration and transmission to request on-demand SSB or on-demand SIB1 may be performed. At 316, the UE 104 may transmit UL-WUS to the NES cell 308 (e.g., a NE 102). At 318, the NES cell 308 may transmit OD-SIB1 or OD-SSB to the UE 104.

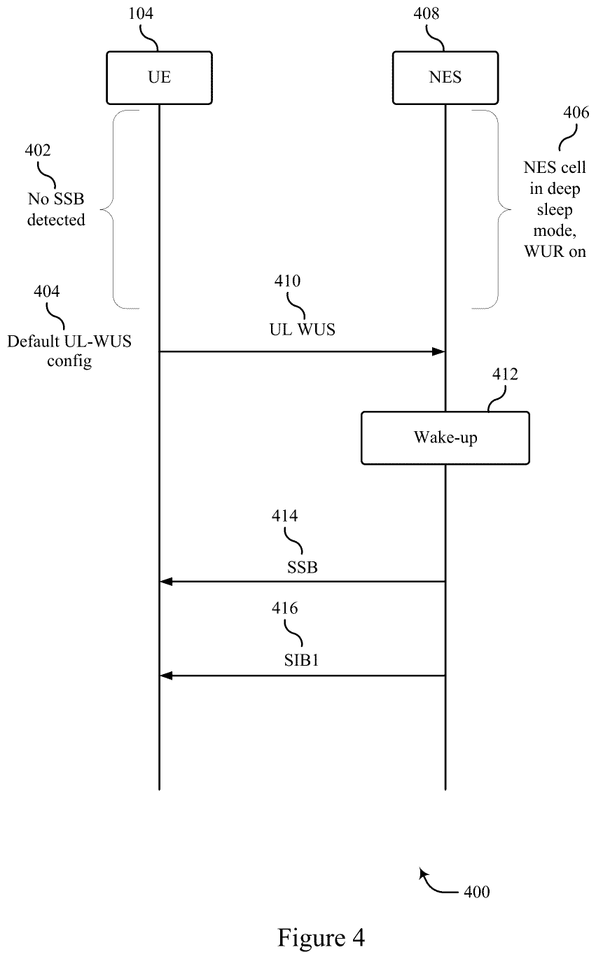

FIG. 4 illustrates an example procedure 400 for a time-domain sequence UL-WUS based on default UL-WUS configuration, in accordance with aspects of the present disclosure. In aspects of this disclosure, a UE 104 upon determining that a serving cell is unavailable, at 402 due to the absence of SSB the UE 104 may enter a default UL-WUS mode. At 404, the default UL-WUS mode includes a default UL-WUS configuration. The default UL-WUS mode may use pre-defined global parameters for transmitting UL-WUS. These parameters are pre-configured, standardized and known for both UE and BS. The configuration may include a fixed uplink bandwidth (RB location), or pre-defined time-domain sequences, e.g., Zadoff-chu sequence, m-sequence, Golay sequence, etc. When no SSB is detected at the UE 104, at 406 an NES 408 may have NES cell in deep sleep mode, while the WUR is on. At 410, the UE 402 may transmit default UL-WUS configuration to the NES 408 through a UL-WUS to wake up the NES 408 at 412. At 414 the NES 404 may transmit SSB to the UE 104 and at 416 the NES 404 may transmit SIB1 to the UE 104.

Here, time domain sequence may be used because frequency based physical random access channel (PRACH) cannot be initiated due to the lack of synchronization that leads to a challenge at BS to find the exact FFT grid. Furthermore, time domain sequence may be used at BS to derive a coarse UL timing information. The default configuration may also contain information of fixed length of time domain sequence, fixed repetition pattern and/or the fixed periodicity of transmitting the sequence. As the UE has no timing reference, UL-WUS sequence may be transmitted without boundary alignment. In one embodiment, the UE transmits the UL-WUS sequence without aligning the UL-WUS transmission to a coarse periodic grid, or without aligning the UL-WUS to a coarse UL timing information. The boundary alignment may be one or more of a fram boundary, a slot boundary, or a symbol boundary associated with a base station. In one implementation, the sequence may be repeated until a response from BS is detected.

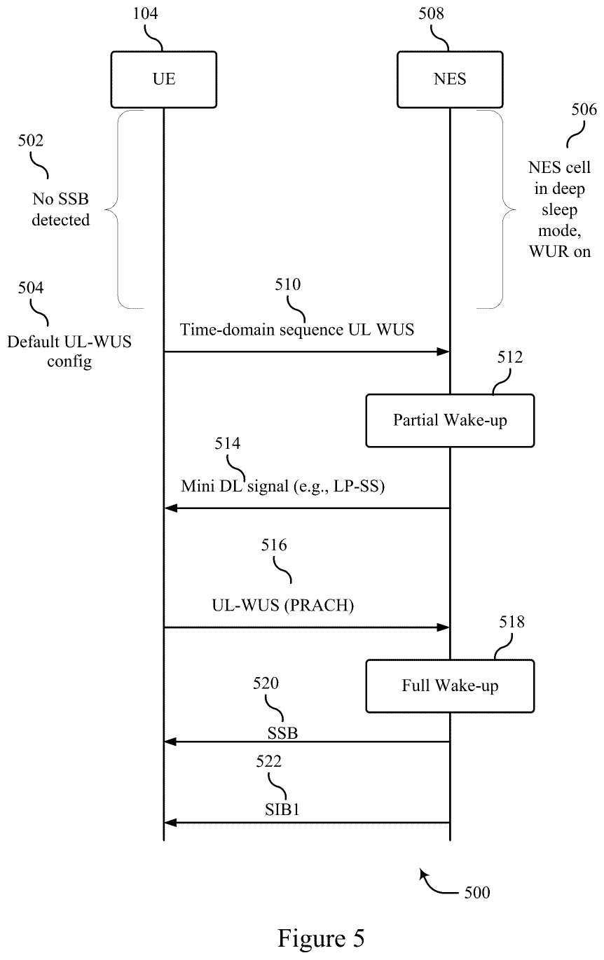

FIG. 5 illustrates an example procedure 500 for a multi-stage UL-WUS, in accordance with aspects of the present disclosure. In aspects of this disclosure, a sequence may be repeated until the maximum duration of UL-WUS transmission is reached. Initially, at 502, a UE 104 may have no SSB detected. At 506, the NES 508 (e.g., a NE 102) may have NES cell in deep sleep mode while WUR is on. The UE 502, if no response is received or if the maximum UL-WUS transmission duration is reached, may increase transmission (Tx) power of UL-WUS transmission. At 510, the UE 104 may transmit a default UL-WUS configuration 504 associated with a time-domain sequence UL-WUS 510 to the NES 508. To avoid interference due to multiple UEs transmitting un-synchronized UL-WUS transmissions at the base station, the UL-WUS may be associated with a time hopping pattern, and/or several sequences can be used. Further, to reduce the interference, the UE 104 may perform some medium sensing prior to such transmission (like Wi-Fi CCA procedure). BS may include low-power WUR that monitors the default (global) UL-WUS on the pre-known bandwidth. BS WUR may perform time-domain correlation of the pre-known sequence. Upon peak detection based on pre-configured threshold, BS WUR may trigger BS main radio to exit deep sleep state and start responding to the UE 104.

In one embodiment, at 512, the NES 508 may enter partial wake-up state and transmit a mini DL signal (e.g., LP-SS) 514 to the UE 104. A mini DL signal may be a very short, low-complexity downlink transmission sent by the gNB whose purpose is early notification to a UE—typically to wake it up or let it stay asleep—without requiring the UE to fully activate its receiver or decode normal control/data channels. The mini DL signal may be a low-power synchronization signal. At 516, the UE 104 may transmit a UL-WUS (PRACH) 516 to the NES 508. At 518, the NES 518 may enter a full wake up state. At 520, the NES 508 may transmit SSB to the UE 104. At 522, the NES 508 may transmit SIB1 to the UE 104.

In one implementation, BS may transmit a complete SSB burst for the UE 104 to start its legacy initial access. In another implementation BS transmits a reduced DL signal. In one implementation the reduced DL signal is mini sync signal to confirm reception of UL-WUS. This signal can be based on low power synchronization signal (LP-SS) and UE 104 after refining its synchronization send UL-WUS with fine frequency/time synchronization. BS after receiving the second UL-WUS transmits full SSB burst. This multi-stage wake-up may help in avoiding power waste of transmitting full SSB burst in case of false alarm detection at BS. After transmission of the reduced DL, the BS may expect to receive an UL-WUS within a window of time. If no UL-WUS is detected, the BS may go back to the sleep mode from the partial-wakeup mode. A full wake-up may refer to the traditional, high-power-consuming method where the device wakes up to decode the control channel (PDCCH) to check for data. In full wake-up procedure, the UE sleeps but wakes up periodically for “on-duration” to check the PDCCH to see if there is any data to receive. A half-wake-up (or Wake-Up Radio, WUR, approach) may use a low-power signal to determine if a full wakeup is necessary. In a half wake up procedure, The UE may remain in a deep sleep mode, with only a very low-power Wake-Up Receiver (WuRx) active. The gNB sends a short, simple wake-up signal (WUS) before the actual data is transmitted.

Solutions related to GNSS-Assisted UL-WUS transmission is described herein. In aspects of this disclosure, a UE upon determining that serving cell is unavailable, due to the absence of SSB, may enter an UL-WUS mode. Before transmitting UL-WUS, UE quipped with GNSS may use GNSS capabilities to obtain a coarse absolute time reference and stable frequency reference. The usage of GNSS capabilities may help in avoiding time and frequency drift during transmitting UL-WUS, and may also enable BS to operate with shorter window, narrower frequency filter, and higher detection threshold to reduce the false alarm of UL-WUS detection. The UE may align UL-WUS transmission to a coarse periodic grid with the help of obtained timing reference from GNSS. The BS WUR may perform a time-domain correlation of the pre-known sequence. Upon peak detection, BS WUR may trigger BS main radio to exit deep sleep state and start transmitting a complete SSB burst or a reduced SSB to enable the UE to acquire time and frequency synchronization. The configuration of time repetition pattern, sequence type, and periodicity of transmitting UL-WUS for UEs with GNSS capabilities and UEs with no GNSS capability may be defined differently in the default UL-WUS configuration.

Aspects of the present disclosure include solutions to UL-WUS transmission with hybrid configuration (stored and default UL-WUS configuration). The UE may store UL-WUS configuration from previous connections. When UE needs access and there is no SSB detected, UE may check first if a stored configuration exists. The UE may use the stored configuration to transmit UL-WUS with the configured bandwidth, sequence, PRACH preamble configuration etc. If no stored configuration exists or if the configuration is expired based on a pre-known time threshold, the UE may fall back to the default/global UL-WUS sequence transmission.

In one embodiment, upon detecting UL-WUS, the BS may activate minimum set of its RF/baseband and transmit a minimum UL-WUS configuration, and transmit UL-WUS that includes more information. For example, the minimum UL-WUS configuration may be PRACH preamble configuration for the UE to refine synchronization.

In aspects of this disclosure, solutions related to UL-WUS configuration for indicating different device types is described herein. The UE may receive UL-WUS configuration from BS, where the UE may select an UL-WUS signal that indicates its device type. For example, a UE may select a specific PRACH preamble to indicate that it is an IoT device, or another preamble to indicates that it is an MBB device. In another example, a UE may select one resource occasion to indicate a certain device type and another resource occasion to indicate another device type. Either a sequence/preamble, a resource occasion, or a combination thereof may be associated with the device type of the UE. BS may transmit different on-demand SIB1 or different content of on-demand SIB1, or any other device specific on-demand SIB based on the device type indicated by the UE in UL-WUS.

In another embodiment, UE may receive UL-WUS configuration from BS, where the UE may send in UL-WUS indication to adapt the periodicity of common channels/signals, e.g., SSB, SIB1, paging, etc. Different UL-WUS sequence/preamble, resource occasion, or a combination thereof may be associated with different periodicity of one or more common channels/signals.

A UE method is disclosed herein. The method may include determining absence of synchronization signal block, selecting a default UL-WUS configuration including a predefined time-domain sequence, predefined sequence length, and predefined repetition pattern, and/or transmitting the predefined time-domain sequence according to default configuration.

In one embodiment, the default configuration may be globally standardized and known to all UEs and BS in a frequency band. The method may also include transmitting the UL-WUS without alignment to any frame boundary of BS, obtaining coarse time reference from a global navigation satellite system (GNSS), and/or aligning UL-WUS transmission of the time-domain sequence to a coarse periodic time grid based on GNSS time reference. The method may further include retrieving UL-WUS configuration from stored information from a previous connection. The UE may fall back to the default UL-WUS configuration when the stored configuration is unavailable or expired according to a pre-defined time duration. The predefined time-domain sequence may include a Zadoff-Chu sequence, a m-sequence, or a Golay sequence.

A BS method is disclosed herein. The method may include monitoring with low-power wake-up receiver (WUR) a predefined uplink bandwidth for a predefined time-domain sequence, performing time-domain correlation between the stored predefined sequence and the received time domain signal and detecting UL-WUS when correlation peak exceeds a predefined threshold, and transmitting a downlink signal in response to a successful peak detection, associated with the predefined pattern, to enable the UE to obtain time and frequency synchronization. The BS may perform a full wake up procedure and sends full SSB burst(s) in the downlink signal. The BS may performs a multi-stage wake up procedure starting with a partial wake up followed by sending a mini downlink signal, then a full wake up followed by sending a full SSB burst(s) upon receiving a response from the UE with a UL-WUS configured based on the mini downlink signal. The threshold of detecting the time-domain sequence may change from a value 1 for the partial wake-up stage to a higher value 2 for the full wake stage.

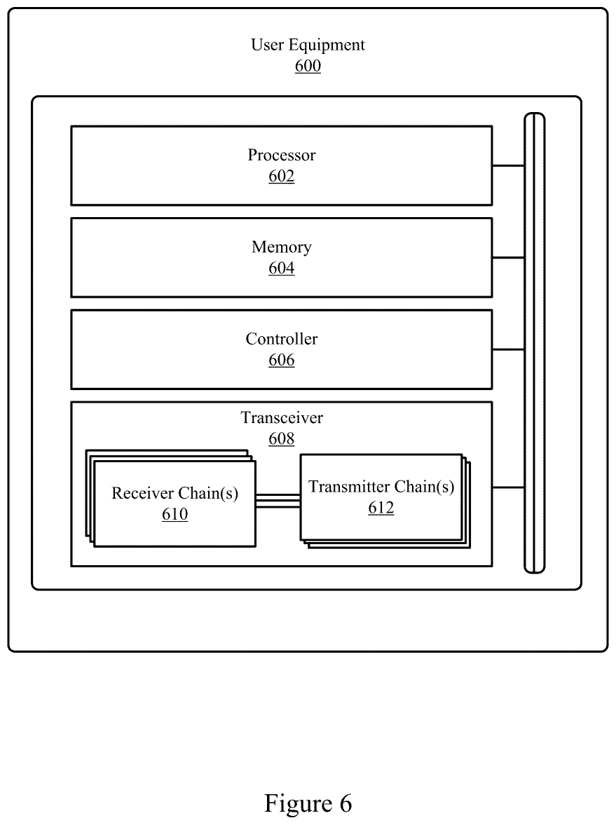

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for determining an absence of a SSB, selecting, based on the absence of the SSB, a default UL-WUS configuration, and transmitting the predefined time-domain sequence according to the default UL-WUS configuration. The default UL-WUS configuration may include a predefined time-domain sequence, predefined sequence length, predefined bandwidth, and predefined repetition pattern. The UE 600 may be configured to or operable to support a means for selecting, based at least in part on an absence of a SSB, a default UL-WUS configuration; and/or transmitting the predefined time-domain sequence according to the default UL-WUS configuration. The default UL-WUS configuration may include a predefined time-domain sequence, a predefined sequence length associated with the predefined time-domain sequence, a predefined bandwidth for transmission of the predefined time-domain sequence, and predefined repetition pattern for transmission of the predefined time-domain sequence.

Additionally, the UE 600 may be configured to support any one or combination of where the predefined bandwidth may be associated with a frequency band for transmission of the predefined time-domain sequence. The UE may transmit, to a base station, the predefined time-domain sequence irrespective of a timing advance associated with the base station. To transmit the predefined time-domain sequence irrespective of the timing advance, UE may transmit the predefined time-domain sequence without aligning transmission of the predefined time-domain sequence to a frame boundary, a slot boundary, or a symbol boundary associated with the base station. The UE may receive a coarse time reference from a GNSS; and align transmission of the predefined time-domain sequence to a coarse periodic time grid based at least in part on the coarse time reference received from the GNSS. The UE may retrieve, from local memory of the UE, a stored UL-WUS configuration. The UE may determine whether the retrieved stored UL-WUS configuration is invalid based at least in part on a time threshold associated with the stored UL-WUS configuration. The default UL-WUS configuration may be selected based at least in part on the retrieved stored UL-WUS configuration being invalid. The UE may determine whether an UL-WUS configurations is stored in local memory of the UE. The default UL-WUS configuration may be selected based at least in part on an absence of a stored UL-WUS configuration in local memory of the UE. The predefined time-domain sequence may include a Zadoff-Chu sequence, a m-sequence, or a Golay sequence.

Additionally, or alternatively, the UE 600 may support at least one memory (e.g., the memory 604) and at least one processor (e.g., the processor 602) coupled with the at least one memory and configured to cause the UE to select, based at least in part on an absence of a SSB, a default UL-WUS configuration; and/or transmit the predefined time-domain sequence according to the default UL-WUS configuration. The default UL-WUS configuration may include a predefined time-domain sequence, a predefined sequence length associated with the predefined time-domain sequence, a predefined bandwidth for transmission of the predefined time-domain sequence, and predefined repetition pattern for transmission of the predefined time-domain sequence.

Additionally, the UE 600 may be configured to support any one or combination of where the predefined bandwidth may be associated with a frequency band for transmission of the predefined time-domain sequence. The UE may transmit, to a base station, the predefined time-domain sequence irrespective of a timing advance associated with the base station. To transmit the predefined time-domain sequence irrespective of the timing advance, UE may transmit the predefined time-domain sequence without aligning transmission of the predefined time-domain sequence to a frame boundary, a slot boundary, or a symbol boundary associated with the base station. The UE may receive a coarse time reference from a GNSS; and align transmission of the predefined time-domain sequence to a coarse periodic time grid based at least in part on the coarse time reference received from the GNSS. The UE may retrieve, from local memory of the UE, a stored UL-WUS configuration. The UE may determine whether the retrieved stored UL-WUS configuration is invalid based at least in part on a time threshold associated with the stored UL-WUS configuration. The default UL-WUS configuration may be selected based at least in part on the retrieved stored UL-WUS configuration being invalid. The UE may determine whether an UL-WUS configurations is stored in local memory of the UE. The default UL-WUS configuration may be selected based at least in part on an absence of a stored UL-WUS configuration in local memory of the UE. The predefined time-domain sequence may include a Zadoff-Chu sequence, a m-sequence, or a Golay sequence.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

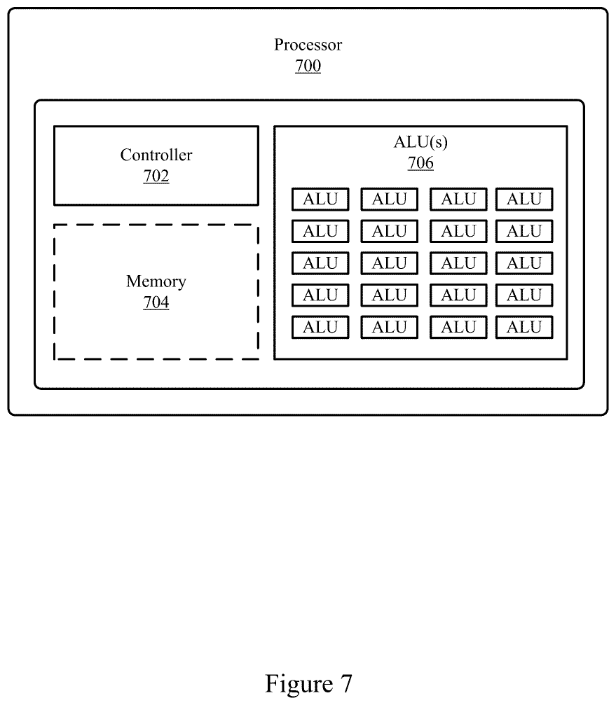

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to select, based at least in part on an absence of a SSB, a default UL-WUS configuration; and/or transmit the predefined time-domain sequence according to the default UL-WUS configuration. The default UL-WUS configuration may include a predefined time-domain sequence, a predefined sequence length associated with the predefined time-domain sequence, a predefined bandwidth for transmission of the predefined time-domain sequence, and predefined repetition pattern for transmission of the predefined time-domain sequence.

Additionally, the processor 700 may be configured to or operable to support any one or combination of where the predefined bandwidth may be associated with a frequency band for transmission of the predefined time-domain sequence. The processor may transmit, to a base station, the predefined time-domain sequence irrespective of a timing advance associated with the base station. To transmit the predefined time-domain sequence irrespective of the timing advance, processor may transmit the predefined time-domain sequence without aligning transmission of the predefined time-domain sequence to a frame boundary, a slot boundary, or a symbol boundary associated with the base station. The processor may receive a coarse time reference from a GNSS; and align transmission of the predefined time-domain sequence to a coarse periodic time grid based at least in part on the coarse time reference received from the GNSS. The processor may retrieve, from local memory of the processor, a stored UL-WUS configuration. The processor may determine whether the retrieved stored UL-WUS configuration is invalid based at least in part on a time threshold associated with the stored UL-WUS configuration. The default UL-WUS configuration may be selected based at least in part on the retrieved stored UL-WUS configuration being invalid. The processor may determine whether an UL-WUS configurations is stored in local memory of the processor. The default UL-WUS configuration may be selected based at least in part on an absence of a stored UL-WUS configuration in local memory of the processor. The predefined time-domain sequence may include a Zadoff-Chu sequence, a m-sequence, or a Golay sequence.

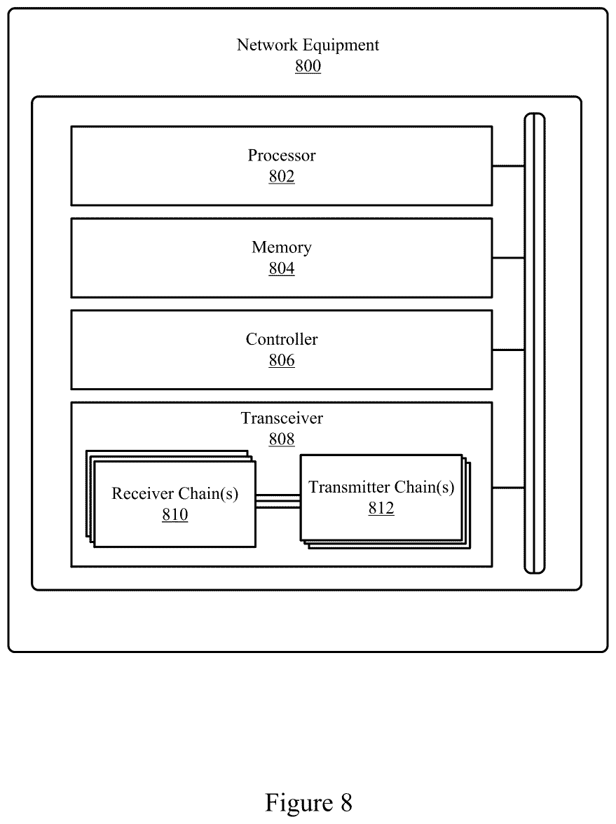

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting a default UL-WUS configuration, and receiving the predefined time-domain sequence according to the default UL-WUS configuration. The default UL-WUS configuration may include a predefined time-domain sequence, a predefined sequence length associated with the predefined time-domain sequence, a predefined bandwidth for transmission of the predefined time-domain sequence, and predefined repetition pattern of transmitting for transmission of the predefined time-domain sequence.

Additionally, the NE 800 may be configured to or operable to support any one or combination of transmitting a default UL-WUS configuration, receiving the predefined time-domain sequence according to the default UL-WUS configuration; and/or performing a full wake up procedure and transmit a full SSB burst in the downlink signal, or performing a multi-stage wake up procedure. The multi-stage wake up procedure may include transmitting a partial wake-up signal, transmitting a mini downlink signal, transmitting a full wake-up signal, and transmitting a full SSB burst upon receiving a response from a UE with a UL-WUS configured based on the mini downlink signal. The predefined threshold may be a value of 1 for the partial wake-up signal. The predefined threshold may be a value of 2 for the full wake-up signal. The default UL-WUS configuration may include a predefined time-domain sequence, a predefined sequence length associated with the predefined time-domain sequence, a predefined bandwidth for transmission of the predefined time-domain sequence, and predefined repetition pattern of transmitting for transmission of the predefined time-domain sequence.

Additionally, or alternatively, the NE 800 may support at least one memory (e.g., the memory 804) and at least one processor (e.g., the processor 802) coupled with the at least one memory and configured to cause the NE to monitor a predefined uplink bandwidth for a predefined time-domain sequence using a low-power WUR. The NE may perform a time-domain correlation between the predefined time-domain sequence and a received time-domain signal. When the time-domain correlation exceeds a predefined threshold, the NE may detect an UL-WUS. The time-domain correlation may be associated with a predefined pattern. The NE may transmit a downlink signal in response to detecting the UL-WUS to enable a UE to obtain time and frequency synchronization.

Additionally, the NE 800 may be configured to support any one or combination of where the NE may perform a full wake up procedure and transmit a full SSB burst in the downlink signal. The NE may perform a multi-stage wake up procedure. The multi-stage wake up procedure may include transmitting a partial wake-up signal, transmitting a mini downlink signal, transmitting a full wake-up signal, and transmitting a full SSB burst upon receiving a response from a UE with a UL-WUS configured based on the mini downlink signal. The predefined threshold may be a value of 1 for the partial wake-up signal. The predefined threshold may be a value of 2 for the full wake-up signal. The NE may monitor the predefined bandwidth for the predefined time-domain sequence using a low-power WUR; receive an UL-WUS based at least in part on a time-domain correlation satisfying a threshold; and/or transmit information, in response to the receive UL-WUS, for time and frequency synchronization. The time-domain correlation may be associated with the predefined repetition pattern

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

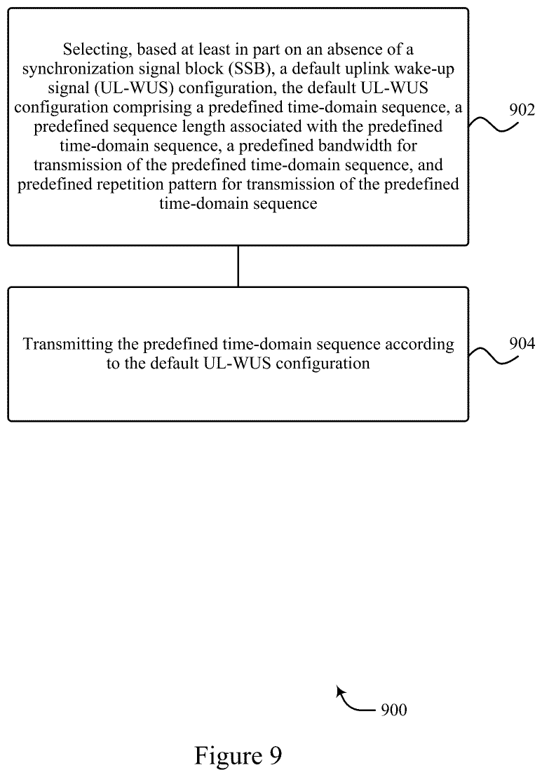

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include selecting, based at least in part on an absence of a synchronization signal block (SSB), a default uplink wake-up signal (UL-WUS) configuration, the default UL-WUS configuration comprising a predefined time-domain sequence, a predefined sequence length associated with the predefined time-domain sequence, a predefined bandwidth for transmission of the predefined time-domain sequence, and predefined repetition pattern for transmission of the predefined time-domain sequence. The operations of 902 may be performed in accordance with examples as described herein. In some implementations, aspects of the operations of 902 may be performed by a UE as described with reference to FIG. 6.

At 904, the method may include transmitting the predefined time-domain sequence according to the default UL-WUS configuration. The operations of 904 may be performed in accordance with examples as described herein. In some implementations, aspects of the operations of 904 may be performed by a UE as described with reference to FIG. 6.

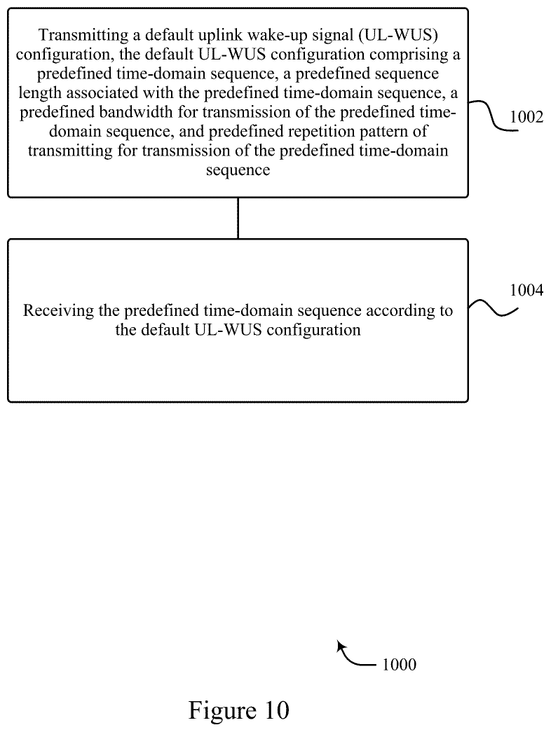

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting a default uplink wake-up signal (UL-WUS) configuration, the default UL-WUS configuration comprising a predefined time-domain sequence, a predefined sequence length associated with the predefined time-domain sequence, a predefined bandwidth for transmission of the predefined time-domain sequence, and predefined repetition pattern of transmitting for transmission of the predefined time-domain sequence. The operations of 1002 may be performed in accordance with examples as described herein. In some implementations, aspects of the operations of 1002 may be performed by an NE as described with reference to FIG. 8.

At 1004, the method may include receiving the predefined time-domain sequence according to the default UL-WUS configuration. The operations of 1004 may be performed in accordance with examples as described herein. In some implementations, aspects of the operations of 1004 may be performed by an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
select, based at least in part on an absence of a synchronization signal block (SSB), a default uplink wake-up signal (UL-WUS) configuration, the default UL-WUS configuration comprising a predefined time-domain sequence, a predefined sequence length associated with the predefined time-domain sequence, a predefined bandwidth for transmission of the predefined time-domain sequence, and predefined repetition pattern for transmission of the predefined time-domain sequence; and
transmit the predefined time-domain sequence according to the default UL-WUS configuration.

2. The UE of claim 1, wherein the predefined bandwidth is associated with a frequency band for transmission of the predefined time-domain sequence.

3. The UE of claim 1, wherein the at least one processor is further operable to cause the UE to:
transmit, to a base station, the predefined time-domain sequence irrespective of a timing advance associated with the base station,
wherein, to transmit the predefined time-domain sequence irrespective of the timing advance, the at least one processor is operable to cause the UE to transmit the predefined time-domain sequence without aligning transmission of the predefined time-domain sequence to a frame boundary, a slot boundary, or a symbol boundary associated with the base station.

4. The UE of claim 1, wherein the at least one processor is further operable to cause the UE to:
receive a coarse time reference from a global navigation satellite system (GNSS); and
align transmission of the predefined time-domain sequence to a coarse periodic time grid based at least in part on the coarse time reference received from the GNSS.

5. The UE of claim 1, wherein the at least one processor is further operable to cause the UE to retrieve, from local memory of the UE, a stored UL-WUS configuration.

6. The UE of claim 5, wherein the at least one processor is further operable to cause the UE to:
determine whether the retrieved stored UL-WUS configuration is invalid based at least in part on a time threshold associated with the stored UL-WUS configuration,
wherein the default UL-WUS configuration is selected based at least in part on the retrieved stored UL-WUS configuration being invalid.

7. The UE of claim 1, wherein the at least one processor is further operable to cause the UE to determine whether an UL-WUS configurations is stored in local memory of the UE,
wherein the default UL-WUS configuration is selected based at least in part on an absence of a stored UL-WUS configuration in local memory of the UE.

8. The UE of claim 1, wherein the predefined time-domain sequence comprises a Zadoff-Chu sequence, a m-sequence, or a Golay sequence.

9. A base station for wireless communication, comprising:
at least one memory; and
at least one processor coupled with the at least one memory and operable to cause the base station to:
transmit a default uplink wake-up signal (UL-WUS) configuration, the default UL-WUS configuration comprising a predefined time-domain sequence, a predefined sequence length associated with the predefined time-domain sequence, a predefined bandwidth for transmission of the predefined time-domain sequence, and predefined repetition pattern of transmitting for transmission of the predefined time-domain sequence; and
receive the predefined time-domain sequence according to the default UL-WUS configuration.

10. The base station of claim 9, wherein the at least one processor is further operable to cause the base station to:
monitor the predefined bandwidth for the predefined time-domain sequence using a low-power wake-up receiver (WUR);
receive an uplink wake-up signal (UL-WUS) based at least in part on a time-domain correlation satisfying a threshold, wherein the time-domain correlation is associated with the predefined repetition pattern; and
transmit information, in response to the receive UL-WUS, for time and frequency synchronization.

11. The base station of claim 10, wherein the at least one processor is further operable to cause the base station to transmit a synchronization signal block (SSB) burst including the information for time and frequency synchronization.

12. The base station of claim 10, wherein the at least one processor is further operable to cause the base station to perform a multi-stage wake up procedure.

13. The base station of claim 12, wherein the multi-stage wake up procedure comprises transmitting a partial WUS, transmitting a mini downlink signal, transmitting a full WUS, and transmitting an SSB burst upon receiving a response from a user equipment (UE), the response includes a UL-WUS configured based at least in part on the mini downlink signal.

14. A method performed by a user equipment (UE), the method comprising:
selecting, based at least in part on an absence of a synchronization signal block (SSB), a default uplink wake-up signal (UL-WUS) configuration, the default UL-WUS configuration comprising a predefined time-domain sequence, a predefined sequence length associated with the predefined time-domain sequence, a predefined bandwidth for transmission of the predefined time-domain sequence, and predefined repetition pattern for transmission of the predefined time-domain sequence; and
transmitting the predefined time-domain sequence according to the default UL-WUS configuration.

15. The method of claim 14, wherein the predefined bandwidth is associated with a frequency band for transmission of the predefined time-domain sequence.

16. The method of claim 14, further comprising:
transmitting, to a base station, the predefined time-domain sequence irrespective of a timing advance associated with the base station,
transmitting the predefined time-domain sequence without aligning transmission of the predefined time-domain sequence to a frame boundary, a slot boundary, or a symbol boundary associated with the base station to transmit the predefined time-domain sequence irrespective of the timing advance,.

17. The method of claim 14, further comprising:
receiving a coarse time reference from a global navigation satellite system (GNSS); and
aligning transmission of the predefined time-domain sequence to a coarse periodic time grid based at least in part on the coarse time reference received from the GNSS.

18. The method of claim 14, further comprising retrieving, from local memory of the UE, a stored UL-WUS configuration.

19. The method of claim 18, further comprising:
determining whether the retrieved stored UL-WUS configuration is invalid based at least in part on a time threshold associated with the stored UL-WUS configuration,
wherein the default UL-WUS configuration is selected based at least in part on the retrieved stored UL-WUS configuration being invalid.

20. A method performed by a base station (BS), the method comprising:
transmitting a default uplink wake-up signal (UL-WUS) configuration, the default UL-WUS configuration comprising a predefined time-domain sequence, a predefined sequence length associated with the predefined time-domain sequence, a predefined bandwidth for transmission of the predefined time-domain sequence, and predefined repetition pattern of transmitting for transmission of the predefined time-domain sequence; and
receiving the predefined time-domain sequence according to the default UL-WUS configuration.
